(19) United States
(12) Patent Application Publication
(10) Pub. No.: US 2007/0118519 A1
(43) Pub. Date: May 24, 2007

(54) Question answering system, data search method, and computer program

(75) Inventors: Miyuki Yamasawa, Kanagawa (JP); Hiroshi Masuichi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/451,457

(22) Filed: Jun. 13, 2006

(30) Foreign Application Priority Data
Nov. 21, 2005 (JP) P2005-336131

(51) Int. Cl. G06F 17/30

(52) U.S. Cl. 707/5

(57) ABSTRACT

A question answering system includes a question sentence analyzing unit, a question keyword identifying unit, a passage acquiring unit and an answer generating unit. The question sentence analyzing unit determines whether or not an input question sentence is an ambiguous question. The question keyword identifying unit extracts a question keyword from the input question sentence. The passage acquiring unit executes a search process to which the question keyword is applied. The answer generating unit generates answers in a form of a list of predicates extracted correspondingly to the question keyword, based on passages acquired by the passage acquiring unit.

### CROSS-REFERENCE TO RELATED APPLICATION

This application claims priority under 35 U.S.C. §119 from Japanese patent application No. 2005-336131, the disclosure of which is incorporated by reference herein.

### BACKGROUND

1. Technical Field

The present invention relates to a question answering system, a data search method and a computer program. Particularly, the present invention relates to a question answering system, a data search method and a computer program in which an answer the most suitable to an ambiguous question to which an answer cannot be determined uniquely can be selectively provided in a system for being input a question sentence and providing an answer to the question.

2. Description of the Related Art

Nowadays, network communications via the Internet or the like are so widespread that various services are provided via networks. A search service is one of the services provided via networks. The search service is a service in which a search server receives a search request from a user terminal such as a personal computer, a cellular phone, or the like, connected to the search server via a network, and the search server executes a process corresponding to the search request and transmits a result of the process to the user terminal.

For example, when the search process via the Internet is executed, a user gains access to a Web site providing a search service, inputs search conditions such as a keyword, a category, etc. in accordance with a menu provided by the Web site. The input search conditions are transmitted to the server. The server executes a process in accordance with these search conditions and shows a result of the process to the user terminal.

There are various modes in the data search process. For example, there are some systems such as a keyword-based search system in which a user inputs a keyword and information listing documents including the input keyword is provided to the user, a so-called question answering system in which a user inputs a question sentence and an answer to the question is provided to the user, etc. In the question answering system, the user does not have to select the keyword. In addition, the question answering system is a system in which the user can receive only answers to the question. Thus, question answering systems have been used broadly.

### SUMMARY

According to one aspect of the invention, a question answering system includes a question sentence analyzing unit, a question keyword identifying unit, a passage acquiring unit and an answer generating unit. The question sentence analyzing unit determines whether or not an input question sentence is an ambiguous question. The question keyword identifying unit extracts a question keyword from the input question sentence. The passage acquiring unit executes a search process to which the question keyword is applied. The answer generating unit generates answers in a form of a list of predicates extracted correspondingly to the question keyword, based on passages acquired by the passage acquiring unit.

A computer program according to one exemplary embodiment of the invention is a computer program that can be provided, for example, to a computer system capable of executing various program codes through a storage medium or a communication medium to be provided in a computer-readable format, for example, a recording medium such as a CD, an FD, an MO or the like, or a communication medium such as a network. When such a program is provided in a computer-readable format, a process corresponding to the program is executed on the computer system.

Other objects, features and advantages of the invention will be made clear in the detailed description based on embodiments of the invention or the accompanying drawings as will be described later. A system in this specification has a configuration of a logical set of a plurality of devices, and the system is not limited to a configuration where the constituent devices are built in one and the same housing.

### BRIEF DESCRIPTION OF THE DRAWINGS

Embodiments of the present invention will be described in detail based on the following figures, wherein:

FIG. 1 is a network configuration diagram showing an example of application of a question answering system according to an exemplary embodiment of the present invention;

FIG. 2 is a diagram for explaining the configuration of a question answering system according to an embodiment of the invention;

FIG. 3 is a diagram showing an example of the system configuration of a syntactic and semantic analysis unit in the question answering system according to the exemplary embodiment of the invention;

FIG. 4 is a table showing examples of answers generated by an answer generating unit in the question answering system according to the exemplary embodiment of the invention;

FIG. 5 is a table showing examples of answers generated by an answer generating unit in the question answering system according to the exemplary embodiment of the invention;

FIG. 6 is a table showing examples of secondary answers provided to a user in the question answering system according to the exemplary embodiment of the invention;

FIG. 7 is a table showing examples of answers in the question answering system according to the exemplary embodiment of the invention;

FIG. 8 is a flowchart for explaining a processing sequence in the question answering system according to the exemplary embodiment of the invention;

FIG. 9 is a table for explaining a function of a narrowing process to be executed by the question answering system according to the exemplary embodiment of the invention; and

FIG. 10 is a table showing examples of answers in the question answering system according to the exemplary embodiment of the invention;

FIG. 11 is a diagram for explaining an example of the hardware configuration of the question answering system according to the exemplary embodiment of the invention.

### DETAILED DESCRIPTION

With reference to the drawings, description will be made below in detail about a question answering system, a data search method and a computer program according to an embodiment of the invention.

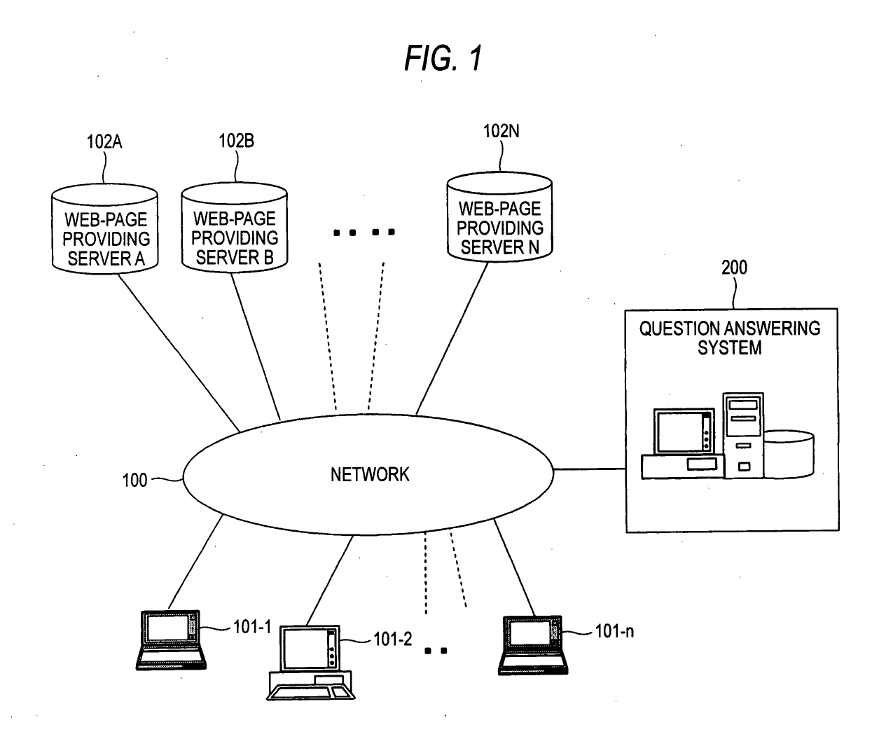

First, with reference to FIG. 1, description will be made about an example of a use mode of a question answering system according to the exemplary invention. FIG. 1 is a diagram showing a network configuration in which a question answering system 200 according to the exemplary invention is connected to a network. A network 100 shown in FIG. 1 is a network such as the Internet or an intranet. Clients 101-1 to 101-n serving as user terminals for transmitting questions to the question answering system 200, and various Web page providing servers 102A to 102N for providing Web pages as raw materials for acquiring answers to the clients 101-1 to 101-n are connected to the network 100.

Various question sentences generated by users are input from the clients 101-1 to 101-n to the question answering system 200, and answers to the input questions are provided to the clients 101-1 to 101-n by the question answering system 200. Answer candidates to the questions are acquired from the Web pages provided by the Web page providing servers 102A to 102N.

The Web page providing servers 102A to 102N provide Web pages as public pages based on a WWW (World Wide Web) system. Each Web page is a set of data to be displayed on a Web browser, which data consist of text data, layout information using HTML, images, sounds or movies embedded in documents, etc. A set of Web pages serve as a Web site. Each Web site consists of a top page (home page) and other Web pages linked from the top page.

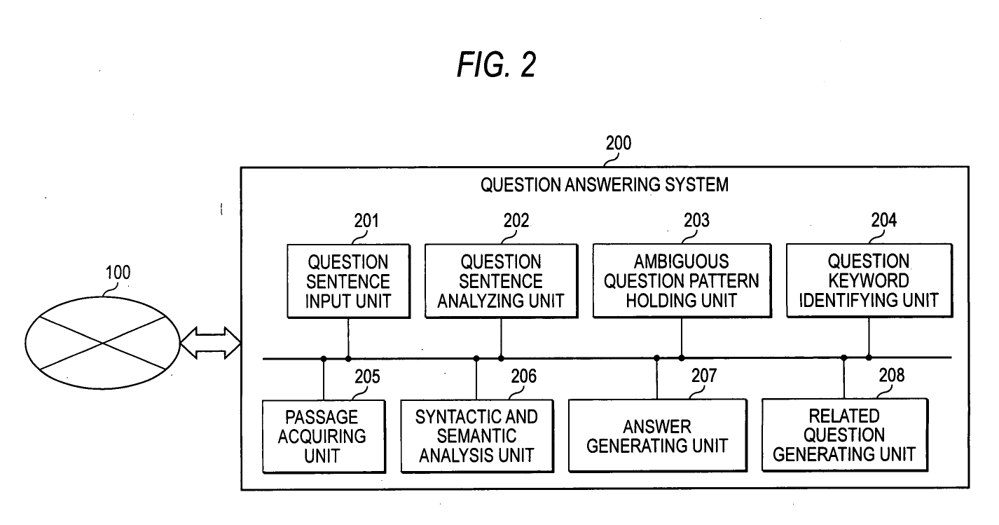

The configuration and processing of the question answering system 200 will be described with reference to FIG. 2. The question answering system 200 is connected to the network 100. The question answering system 200 executes the following process. That is, the question answering system 200 receives a question sentence from each client connected to the network 100. The question answering system 200 searches information sources which are Web pages provided by Web page providing servers connected to the network 100. Thus, the question answering system 200 acquires answer candidates. The question answering system 200 selects proper answers from the acquired answer candidates and provides the proper answers to the client.

The question answering system 200 has a question sentence input unit 201, a question sentence analyzing unit 202, an ambiguous question pattern holding unit 203, a question keyword identifying unit 204, a passage acquiring unit 205, a syntactic and semantic analysis unit 206, an answer generating unit 207 and a related question generating unit 208 as shown in FIG. 2. Description will be made below about processes to be executed by these means in the question answering system 200 respectively.

[Question Sentence Input Unit]

A question sentence (input question) from a user is input to the question sentence input unit 201 through the network 100. In the question answering system according to the exemplary embodiment of the invention, not only questions asking, for example, personal names or place names as answers, but also questions [ambiguous questions] asking, for example, degree, tendency, etc., to which answers cannot be selected uniquely, are input, and proper answers to the questions are provided to users.

Description will be made below in detail about an example in which the following ambiguous question was input as a question input from a user.

“How about business of next year?”

[Question sentence analyzing unit and Ambiguous Question Pattern Holding Unit]

The question sentence analyzing unit 202 executes a process for analyzing an input question, and determines whether the question is an ambiguous question or not. Ambiguous question pattern information registered in the ambiguous question pattern holding unit 203 in advance is applied to this determination process.

Ambiguous question pattern information is registered and held in the ambiguous question pattern holding unit 203. That is, a set of question patterns corresponding to ambiguous questions asking degree, tendency, etc. are held. Examples of the question patterns corresponding to ambiguous questions include:

“How about [*1]?” . . . (1)

“How is [*1] doing?” . . . (2)

“Is [*1] [*2]?” . . . (3)

[*1] designates an arbitrary character string, and [*2] designates an adjective or a phrase comparable to an adjective. In addition to the question patterns (1) to (3), the ambiguous question patterns include other question patterns such as:

“How {is/will be/was} [*1]?”

The ambiguous question pattern holding unit 203 holds question patterns corresponding to these ambiguous questions. The question sentence analyzing unit 202 executes a process for analyzing an input question so as to analyze whether the input question is a question corresponding to any ambiguous question pattern held by the question pattern holding unit 203 or not. Thus, the question sentence analyzing unit 202 determines whether the question from a user is an ambiguous question or not. In this embodiment, the following question has been input.

“How about business of next year?”

This question corresponds to:

“How about [*1]?”

The question is regarded as an ambiguous question.

Any ambiguous question process is processed by a process, which will be described below. As for any question that is not an ambiguous question but a question to which an answer can be selected uniquely, such as a question asking a personal name or a place name, search based on a keyword extracted from the question is executed to provide the answer to the user in the same manner as in the question answering system according to the background art. A typical configuration of this process is, for example, disclosed in JP2002-132811A, entire contents of which are incorporated herein by reference.

[Question keyword identifying unit]

The question keyword identifying unit 204 executes a process for extracting a keyword to be used for search, from a question corresponding to an ambiguous question pattern. The question keyword identifying unit 204 extracts a keyword based on a question pattern such as:

“How about [*1]?” . . . (1)

“How is [*1] doing?” . . . (2)

“Is [*1] [*2]?” . . . (3)

For example, specifically, the question keyword identifying unit 204 identifies a question keyword from a portion corresponding to [*1] of the question pattern.

The question keyword is a character string taking a leading part of the question. The method for identifying the question keyword is executed as a process for extracting a principal word from the portion corresponding to [*1] of the question pattern. For example, the portion corresponding to [*1] of the question pattern is resolved into a pattern of:

“[*4] of [*3]” . . . (4)

The part [*4] is identified as the question keyword:

As an example of a specific question, the following question is input here.

“How about business of next year?”

This question corresponds to:

“How about [*1]?” . . . (1)

In this question, “business of next year” corresponds to [*1], and thus [*4] corresponds to “business”. Therefore, “business” is identified as a question keyword. When it can be concluded that the portion corresponding to [*1] is not eligible to be divided into smaller pieces, for example, when the portion corresponding to [*1] is a proper expression or the like, the portion corresponding to [*1] is used as a question keyword as it is.

[Passage Acquiring Unit]

The passage acquiring unit 205 retrieves passages with a search formula using the question keyword selected by the question keyword identifying unit 204. The passages mean, of pieces to be searched, text portions which seem to include answers. The pieces to be searched may be texts on WWW or may be specific databases.

Any existing passage acquiring method based on a keyword can be applied to the passage acquiring unit 205. For example, retrieval using a retrieval module of a question answering system SAIQA-QAC2 disclosed in detail by Isozaki, H. in “NTT's Question Answering System for NTCIR QAC2”, Working Notes of NTCIR-4 Workshop. pp. 326-332 (2004), entire contents of which are incorporated herein by reference, is performed so that passages retrieved with a search formula using the question keyword selected by the question keyword identifying unit 204 are acquired.

In this processing example, passages are retrieved with a search formula using the question keyword “business” selected from the question “How about business of next year?” by the question keyword identifying unit 204.

For example, the following passages may be retrieved.

(a) [Business on and after the second half of next year may considerably slow down but the rate of economic growth this year will be kept at 2-3%.]

(b) [However, we are extremely pessimistic about future prospects because only 20 percentages of persons answered that business would get on track to recovery by the end of next year.]

(c) [General Manager: We expect business will recover next year because the government of Japan took measures to boost is the economy many times with a large-scale budget for emergency economic measures or the like.]

[Syntactic and Semantic Analysis Unit]

The syntactic and semantic analysis unit 206 performs syntactic and semantic analysis upon a passage retrieval result acquired by the passage acquiring unit 205. Description will be made about a syntactic and semantic analysis process. Natural languages described in various languages such as Japanese, English, etc. are characterized by abstraction and high ambiguity essentially. However, when sentences are dealt with mathematically, computer processing can be performed thereon. As a result, various applications/services about natural languages, such as machine translation or interactive systems, search systems, question answering systems, etc., can be implemented by automated processing. Such natural language processing is generally divided into respective processing phases of morpheme analysis, syntactic analysis, semantic analysis and contextual analysis.

In the phase of morpheme analysis, any sentence is segmented into morphemes, which are minimum semantic units, and processing to designate parts of speech is performed thereon. In the phase of syntactic analysis, the structure of the sentence including a phrase structure and so on is analyzed on the basis of grammatical rules. Since the grammatical rules have a tree structure, a result of the syntactic analysis generally has a tree structure in which individual morphemes are connected based on relations of modification etc. In the phase of semantic analysis, a semantic structure expressing meanings carried by the sentence is obtained based on meanings (concepts) of words in the sentence, semantic relations among the words, and so on, so as to compose a semantic structure. In the phase of contextual analysis, a composition (discourse) which is a series of sentences is regarded as a basic unit of analysis, and a semantic consistency among the sentences is obtained to compose a discourse structure.

In the field of natural language processing, syntactic analysis and semantic analysis are believed to be a technique essential to implement applications such as interactive systems, machine translation systems, proofreading support systems, text summarizing systems, etc.

In the phase of syntactic analysis, a natural language sentence is received, and a process for determining relations of modification among words (phrases) based on grammatical rules is performed on the sentence. A result of the syntactic analysis can be expressed by a form of a tree structure (dependency tree) called a dependency structure. In the phase of semantic analysis, a process for determining case relations in the sentence based on the relations of modification among the words (phrases) can be performed. The case relations mentioned herein designate grammatical roles of respective components composing the sentence, such as a subject (SUBJ), an object (OBJ), etc. The semantic analysis may include a process for determining the tense, modality, discourse, etc. of the sentence.

As for an example of the syntactic and semantic analysis system, a natural language processing system based on LFG (Lexical Functional Grammar) is described in detail by Masuichi and Ohkuma “Constructing A Practical Japanese Parser Based on Lexical-Functional Grammar”, Journal of Natural Language Processing, Vol. 10, No. 2, pp. 79-109 (2003), entire contents of which are incorporated herein by reference.

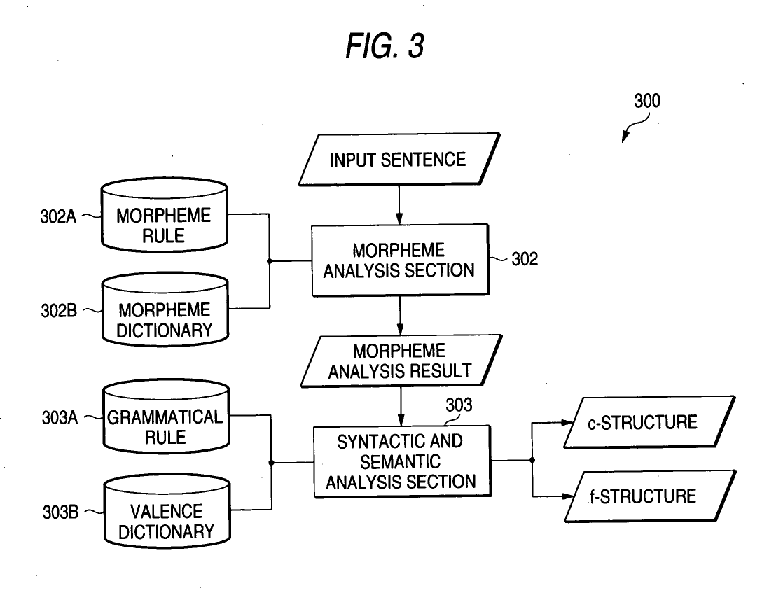

FIG. 3 shows the configuration of a syntactic and semantic analysis system 300 for executing natural language processing based on LFG. A morpheme analysis section 302 has a morpheme rule 302A and a morpheme dictionary 302B about a specific language such as Japanese. In the morpheme analysis section 302, an input sentence is segmented into morphemes which are minimum semantic units, and processing to designate parts of speech is performed thereon.

Next, the morpheme analysis result obtained thus is input to a syntactic and semantic analysis section 303. The syntactic and semantic analysis section 303 has dictionaries such as a grammatical rule 303A, a valence dictionary 303B, etc., so as to analyze a phase structure based on grammatical rules and so on, and analyze a semantic structure expressing meanings carried by the sentence based on meanings of words in the sentence, semantic relations among the words, etc. (the valence dictionary describes relations between a verb and another constituent component of the sentence, such as a subject, so that semantic relations between a predicate and words related thereto can be extracted). As a result of parsing, the syntactic and semantic analysis section 303 outputs a “c-structure (constituent structure)” expressing a phase structure of the sentence constituted by words, morphemes, etc. as a tree structure, and an “f-structure (functional structure)” obtained as a result of semantic and functional analysis in which the input sentence is analyzed as an interrogative sentence, a past tense sentence, a polite sentence, or the like, based on a case structure of a subject, an object, etc.

That is, the c-structure expresses the structure of a natural language sentence as a tree structure in which morphemes of the sentence are arranged in superordinate phrases. The f-structure expresses semantic information of the case structure, tense, modality, discourse, etc. of the sentence as an attribute-attribute value matrix structure based on concepts of grammatical functions.

Also in the question answering system according to the exemplary embodiment of the invention, this natural language processing system based on LFG can be applied to the syntactic and semantic analysis unit 206. The syntactic and semantic analysis unit 206 performs natural language processing based on LFG over a passage retrieval result acquired by the passage acquiring unit 205.

[Answer Generating Unit]

The answer generating unit 207 extracts predicates of a question keyword from the passage retrieval result, which is based on the question keyword and acquired by the passage acquiring unit 205, and arranges the extracted predicates so as to generate answers. The syntactic and semantic analysis processing result executed over the passage retrieval result by the syntactic and semantic analysis unit 206 is applied to the extraction of the predicates. When there is a modification component frequently appearing together with a predicate, it is assumed that the predicate including the modification component is dealt with as one predicate. A statistical method may be used for arranging the predicates.

From the examples of passages retrieved by the passage acquiring unit 205, the following pairs of the question keyword and the predicates are extracted by the syntactic and semantic analysis of the syntactic and semantic analysis unit 206.

(business, slow down)

(business, get on track to recovery)

(business, recover)

That is, the question keyword selected from the question “How about business of next year?” is “business”. From the aforementioned retrieved passage:

(a) [Business on and after the second half of next year may considerably slow down but the rate of economic growth this year will be kept at 2-3%.]

the following pair of the question keyword and a predicate is extracted by syntactic and semantic analysis of the syntactic and semantic analysis unit 206:

(business, slow down)

In the same manner, from the retrieved passage:

(b) [However, we are extremely pessimistic about future prospects because only 20 percentages of persons answered that business would get on track to recovery by the end of next year.] the following pair of the question keyword and a predicate is extracted by syntactic and semantic analysis of the syntactic and semantic analysis unit 206:

(business, get on track to recovery)

In the same manner, from the retrieved passage:

(c) [General Manager: We expect business will recover next year because the government of Japan took measures to boost the economy many times with a large-scale budget for emergency economic measures or the like.]

the following pair of the question keyword and a predicate is extracted by syntactic and semantic analysis of the syntactic and semantic analysis unit 206:

(business, recover)

In the aforementioned example, description has been made about an example of processing in which pairs of the question keyword and predicates are extracted from three retrieved passages, that is:

(a) [Business on and after the second half of next year may considerably slow down but the rate of economic growth this year will be kept at 2-3%.]

(b) [However, we are extremely pessimistic about future prospects because only 20 percentages of persons answered that business would get on track to recovery by the end of next year.]

(c) [General Manager: We expect business will recover next year because the government of Japan took measures to boost the economy many times with a large-scale budget for emergency economic measures or the like.]

Description has been made on the processing example in which pairs of the question keyword and predicates correspondingly to these passages are extracted.

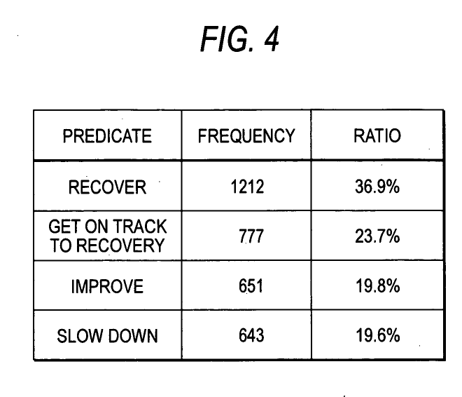

In an actual example of search processing, data examples of pairs of the question keyword and predicates acquired by syntactic and semantic analysis of the syntactic and semantic analysis unit 206 based on all the results acquired by retrieval of passages based on the question keyword [business] by the passage acquiring unit 205 are shown in FIG. 4.

FIG. 4 is a table showing corresponding data among predicates extracted from retrieved passages in accordance with the question keyword “business”, detection frequencies of the predicates, and detection percentages of the predicates.

The number of retrieved passages having the predicate “recover” in relation to “business” is 1,212, and the ratio to the total number of retrieved passages is 36.9%.

The number of retrieved passages having the predicate “get on track to recovery” in relation to “business” is 777, and the ratio to the total number of retrieved passages is 23.7%.

The number of retrieved passages having the predicate “improve” in relation to “business” is 651, and the ratio to the total number of retrieved passages is 19.8%.

The number of retrieved passages having the predicate “slow down” in relation to “business” is 643, and the ratio to the total number of retrieved passages is 19.6%.

For example, the statistical data shown in FIG. 4 are provided to the user as answers to the question of the user, that is:

question “How about business of next year?”

The user can acquire the following statistical data and acquire proper answers to the question.

(a) business will recover=36%

(b) business will get on track to recovery=23.7%

(c) business will improve=19.8%

(d) business will slow down=19.6%

When the answers as shown in FIG. 4 are provided to the user, it is preferable that a statistical method about frequencies, ratios, etc. is used for placing a plurality of predicates and components modifying the predicates in the order, as shown in FIG. 4.

[Related Question Generating Unit]

The related question generating unit 208 is used when more detailed answers is provided to a user in addition to answers, which are generated by the answer generating unit 207 and provided to the user, that is, the aforementioned statistical data. The related question generating unit 208 expands the input question based on the predicates extracted from the retrieved passages correspondingly to the question keyword “business” by the answer generating unit 207. Thus, the related question generating unit 208 generates related questions. Further search is executed by use of the expanded questions so as to acquire related information. The related information is provided to the user.

In this example of processing, the input question:

“How about business of next year?”

is expanded based on the predicates extracted from the retrieved passages correspondingly to the question keyword “business” by the answer generating unit 207. Thus, related questions aregenerated. Further search is executed by use of the expanded questions so as to acquire related information. The related information is provided to the user.

In this example of processing, for example, the following predicates are obtained as predicates extracted from the retrieved passages correspondingly to the question keyword “business” by the answer generating unit 207.

“recover”

“slow down”

The related question generating unit 208 generates related questions to which these predicates are applied, as follows.

(a) Based on the predicate “recover”:

(related question a1) “From when will business recover?”

(related question a2) “Who says business of next year will recover?

(b) Based on the predicate “slow down”:

(related question b1) “From when will business slow down?”

(related question b2) “Who says business of next year will slow down?”

In this manner, the related question generating unit 208 generates new questions as related questions to which the predicates extracted from the retrieved passages correspondingly to the question keyword “business” by the answer generating unit 207 are applied.

Description will be made below about the method in which the related question generating unit 208 generates related questions. By way of example, description will be made about the method for generating the following question as a related question.

“From when will business recover?”

The related question generating unit 208 holds a plurality of related question generating patterns in advance. For example, the related question generating unit 208 holds the following related question generating patterns.

“From when will [*4] [*5]?” . . . (5)

“Who says [*1] will [*5]?” . . . (6)

Assume that [*1] and [*4] designate phrases including the question keyword “business”, and [*5] designates a predicate (e.g. “recover”) of a passage derived as an answer.

The related question generating unit 208 determines answerability when a related question generating pattern is used to generate a related question. For example, in the following related question pattern:

“From when will [*4] [*5]?”

whether or not expression indicating time is included in retrieved passages including “recover” is determined by use of the syntactic and semantic analysis unit 206. When expression indicating time is not included in any retrieved passage including “recover”, it is concluded that it is impossible to acquire a proper answer to the related question:

“From when will [*4] [*5]?”

In the same manner, answerability of the other related question pattern is determined.

By these processes, answerabilities when the related question generating patterns are used to generate related questions are determined. The related questions are generated using the related question generating patterns determined to be answerable. Passages are retrieved based on the related questions, and results thereof are provided to the user as secondary answers.

Setting may be made as follows. That is, the statistical data generated by the answer generating unit 207 as described previously with reference to FIG. 4 are provided as primary answers to the user so that the user can select a predicate as an answer from a list of the primary answers. In this case, when a specific predicate is selected by the user, passages are retrieved again with the question keyword, and components (subjects or modifiers) modifying the selected predicate are extracted by the syntactic and semantic analysis unit and provided to the user.

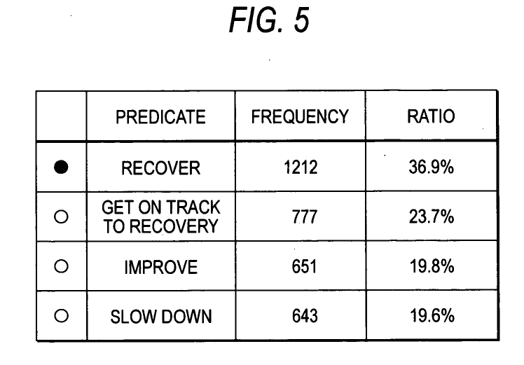

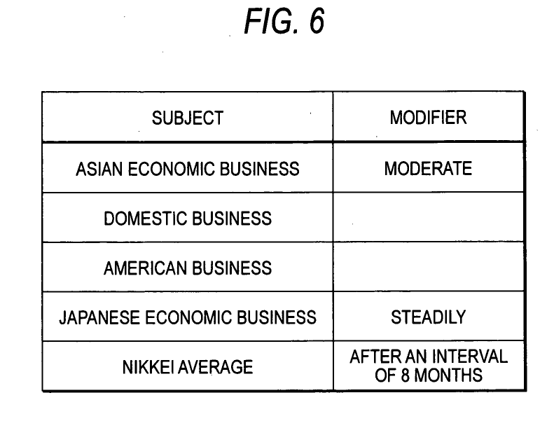

For example, the statistical data generated by the answer generating unit 207 are provided as primary answers to the user in a selectable form as shown in FIG. 5. When information of a predicate (e.g. “recover”) selected by the user is input to the question answering system, the question answering system retrieves passages again with the question keyword “business”, and executes syntactic and semantic analysis over the retrieved passages by means of the syntactic and semantic analysis unit 206. Thus, components (subjects or modifiers) modifying the selected predicate “recover” are extracted and provided to the user. For example, data set as a list of components (subjects or modifiers) modifying the selected predicate “recover” as shown in FIG. 6 are provided as secondary answers to the user.

The subjects provided in the secondary answers do not always include the question keyword. When such a search process is executed, related information which cannot be supported by the patterns held in advance can be obtained in retrieval strategy.

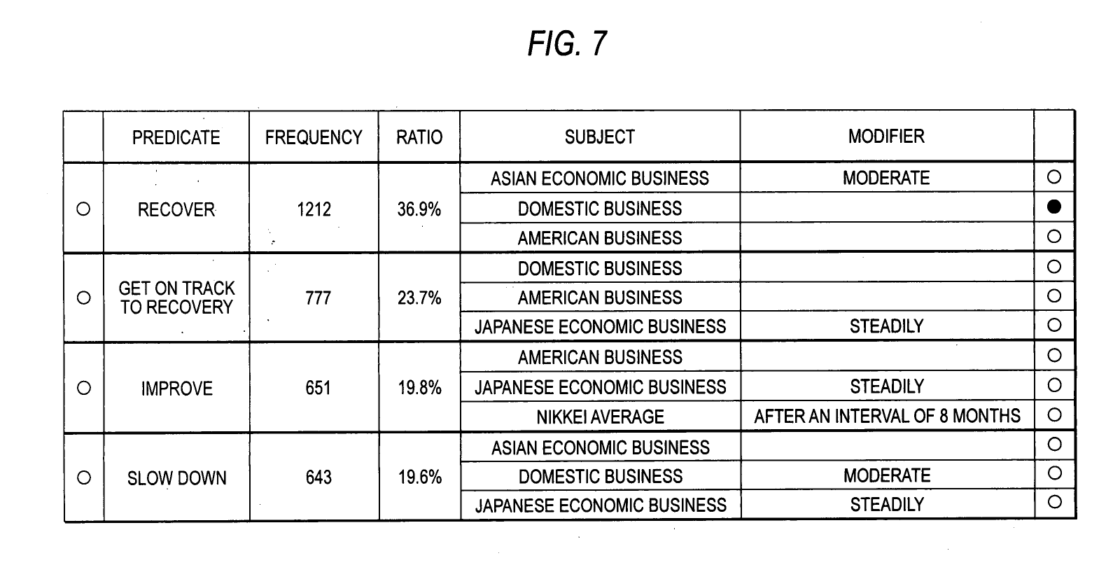

The method for providing answers to a user may be arranged not as the aforementioned method in which answers are classified into primary answers and secondary answers but as a method in which both the primary answers and the secondary answers are provided as primary answers. FIG. 7 shows an example of answer data according to this method. As shown in FIG. 7, of components (subjects or modifiers) modifying predicates, ranking ones may be extracted and included as reference information in the primary answers so that they can be selected. This method will be described below.

In this case, the user can select a predicate in the same manner as the method for providing answers as described above, so as to refer to the fourth and following ranking components modifying the predicate. In addition, the user can obtain related information in retrieval strategy. For example, the related information includes passages or documents of the sources from which the components were extracted.

Various other methods can be applied to the method for providing answers to the user. For example, a plurality of components modifying predicates can be selected so that the user can compare related information of one component with that of another. In such a manner, there are variations of devices, settings, etc. in accordance with applications.

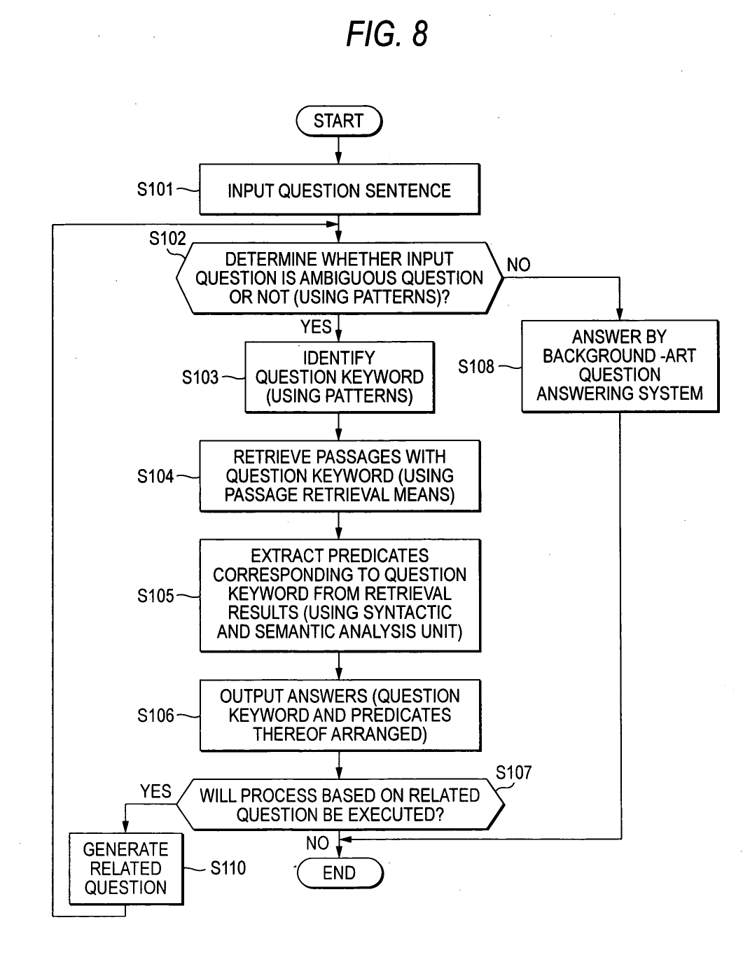

Next, with reference to the flow chart of FIG. 8, description will be made about a processing sequence to be executed by the question answering system according to the exemplary embodiment of the invention.

In Step S101, a question from a client is input. In Step S102, a process for analyzing the question input from the client is executed to determine whether the question sentence is an ambiguous question or not. That is, the question sentence analyzing unit 202 executes a process for analyzing the input question so as to determined whether the question is an ambiguous question or not. Information about ambiguous question patterns registered in the ambiguous question pattern holding unit 203 in advance are applied to this determination process.

Specifically, as described previously, it is determined whether the input question corresponds to one of the ambiguous question patterns held by the ambiguous question pattern holding unit 203 or not. The ambiguous question patterns include:

“How about [*1]?” . . . (1)

“How is [*1] doing?” . . . (2)

“Is [*1] [*2]?” . . . (3)

[*1] designates an arbitrary character string, and [*2] designates an adjective or a phrase comparable to an adjective.

When it is concluded in Step S102 that the input question is not an ambiguous question, that is, the input question is a question to which an answer can be selected uniquely, that is, a question asking a personal name or a place name by way of example, the routine of processing proceeds to Step S108. In Step 108, search is executed based on a keyword extracted from the question in the same manner as in a background-art question answering system, and a result of the search is provided to the user. A typical configuration of this process is, for example, disclosed in JP-A-2002-132811.

When it is concluded in Step S102 that the input question is an ambiguous question, the routine of processing proceeds to Step S103. In Step S103, the question keyword identifying unit 204 executes a process for extracting a keyword to be applied to search from the question corresponding to an ambiguous question pattern. The question keyword identifying unit 204 extracts a keyword based on the following question patterns.

“How about [*1]?” . . . (1)

“How is [*1] doing?” . . . (2)

“Is [*1] [*2]?” . . . (3)

Specifically, for example, the question keyword identifying unit 204 identifies a question keyword from a portion corresponding to [*1] of the question patterns.

Next, in Step S104, passages are retrieved based on the question keyword. That is, the passage acquiring unit 205 retrieves passages with a search formula using the question keyword selected by the question keyword identifying unit 204. The passages mean, of pieces to be searched, text portions which seem to include answers. The pieces to be searched may be texts on WWW or may be specific databases.

Next, in Step S105, predicates related to the question keyword are extracted from a result of the search. This extraction is executed by the syntactic and semantic analysis unit 206. A syntactic and semantic analysis process is executed on the passage retrieval result so as to extract predicates related to the question keyword.

Next, in Step S106, answers to be provided to the user are generated and output. This is a process to be performed by the answer generating unit 207. The answer generating unit 207 arranges the predicates related to the question keyword and extracted by the syntactic and semantic analysis unit 206, based on the passage retrieval result acquired in accordance with the question keyword by the passage acquiring unit 205. Thus, the answer generating unit 207 generates answers. The answers are provided, for example, in a form of a list of predicates related to the question keyword as shown in FIG. 4 or FIG. 5.

By this presentation of answers, for example, the following statistical data can be provided to the user as answers to the question “How about business of next year?”.

(a) business will recover=36%

(b) business will get on track to recovery=23.7%

(c) business will improve=19.8%

(d) business will slow down=19.6%

Thus, proper answers to the question can be provided.

Next, in Step S107, it is determined whether a process based on related questions should be executed or not. For example, this determination process may be executed in accordance with a request from the user. Alternatively, setting may be made so that related questions are generated based on the information set in the question answering system and determination is then made as to whether the process should be continued or not.

When the process based on related questions is not executed, the routine of processing is terminated. When the process based on related questions is executed, related questions are generated in Step S110, and the routine of processing returns to Step S102, where similar processing is executed. The process for generating related questions in Step S110 is a process to be executed by the related question generating unit 208.

The related question generating unit 208 expands the input question based on the predicates extracted from the retrieved passages correspondingly to the question keyword (e.g. “business”) by the answer generating unit 207. Thus, the related question generating unit 208 generates related questions. After that, based on the generated related questions, Step S102 and the following processing are executed, and further search is executed so as to acquire related information. The related information is provided to the user. The provided answers, for example, serve as secondary answers shown in FIG. 6.

### Other Embodiments and Modifications

Next, description will be made about embodiments and modifications in which details of the aforementioned question answering system have been changed.

(1) Addition of Passage Classifying Unit

A passage classifying unit having a function of classifying passages obtained by the passage acquiring unit 205 executing a search process may be added. In this case, the passages are classified in accordance with the times when the passages were created, respectively. Generally, data to be searched, such as Web page data, have attribute information attached thereto. The attribute information includes the time where the data were created. Based on the attribute information, the passage classifying unit classifies each passage obtained by the passage acquiring unit 205, in accordance with the time when the passage was created. With this configuration, a list of answers arranged in the temporal order can be generated and provided to the user. As for the method by which a large amount of documents can be browsed efficiently in time series, for example, a time-series browsing process configuration can be used. The process configuration is disclosed in detail in JP 2004-86534 A, entire contents of which are incorporated herein by reference. When passages are classified respectively in accordance with the times when the passages were created, it is possible to analyze trend or tendency about the question keyword in consideration of time series.

(2) Addition of Unit for Holding Human Relation Data and Unit for Identifying Creators from Passages

A function of acquiring passage creator information attached to passages as attribute information of the passages and obtained by the passage acquiring unit 205 for executing a search process, and arranging the passages based on human relation data held by a human relation data holding unit is added. For example, a human relation data generating method described in detail in JP 2004-348179 A, entire contents of which are incorporated herein by reference is used as the method for generating the human relation data or a method for achieving excellent information support based on the human relation data. According to this configuration, it is possible to analyze trend or tendency about the question keyword in consideration of human relations.

(3) Addition of Predicate Narrowing Function

A predicate narrowing function in which predicates to be used for generating answers in the answer generating unit 207 are narrowed in accordance with the ambiguous question pattern corresponding to the input question is added. Detailed description will be made below about an example in which the following question is input to the question answering system as an ambiguous question.

“Is ‘Howl's Moving Castle’ interesting?”

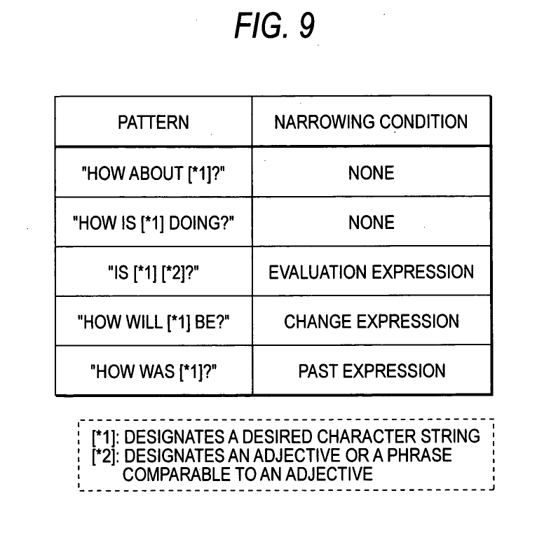

The ambiguous question pattern holding unit 203 holds answer narrowing conditions as well as a set of question patterns for asking degree, tendency, etc. FIG. 9 shows examples of patterns with narrowing conditions. FIG. 9 shows the patterns and the narrowing conditions only by way of example. Patterns and narrowing conditions are not limited to these illustrated ones.

That is, FIG. 9 shows:

(a) a pattern “How about [*1]?” with no narrowing condition;

(b) a pattern “How is [*1] doing?” with no narrowing condition;

(c) a pattern “Is [*1] [*2]?” with a narrowing condition [evaluation expression];

(d) a pattern “How will [*1] be?” with a narrowing condition [change expression]; and

(e) a pattern “How was [*1]?” with a narrowing condition [past expression]

[*1] designates an arbitrary character string, and [*2] designates an adjective or a phrase comparable to an adjective.

The question “Is Howl's Moving Castle interesting?” corresponds to the following pattern of the aforementioned patterns.

“Is [*1] [*2]?”

Therefore, the question keyword identifying unit 204 regards the question as a question whose predicate should be narrowed. Since the portion of the question corresponding to [*1] is a proper name, the question keyword identifying unit 204 sets “Howl's Moving Castle” as a question keyword.

The passage acquiring unit 205 retrieves passages with a search formula using the question keyword “Howl's Moving Castle”. Examples of retrieved passages include:

(i) “Howl's Moving Castle” is as interesting as expected!

(ii) “Howl's Moving Castle” was good.

(iii) The latest movie “Howl's Moving Castle” of STUDIO GHIBLI headed by Hayao Miyazaki and very much talked of as the world's greatest animation studio due to the high quality and high hit rate of works the studio has produced till now is a unique work showing high quality enough to keep trust with the audience who have loved GHIBLI's works with excessive expectation, while leaving a feeling of wrongness the strongest of the GHIBLI's works up to now.

(iv) “Howl's Moving Castle” circulated by media will be inspected thoroughly.

(v) Howl's Moving Castle was taken in.

The syntactic and semantic analysis unit 206 performs syntactic and semantic analysis upon the aforementioned passage retrieval results (i) to (v). As for the syntactic and semantic analysis system, it is, for example, possible to use the aforementioned LFG system described in detail by Masuichi and Ohkuma “Constructing A Practical Japanese Parser Based on Lexical-Functional Grammar”, Journal of Natural Language Processing, Vol. 10, No. 2, pp. 79-109 (2003).

The answer generating unit 207 extracts predicates corresponding to the question keyword from the passage retrieval results using the question keyword, and arranges the extracted predicates. Thus, the answer generating unit 207 generates answers. The question keyword extracted by the syntactic and semantic analysis unit from the passage examples retrieved by the passage acquiring unit 205 is paired with predicates as:

(i) (Howl's Moving Castle, is interesting)

(ii) (Howl's Moving Castle, was good)

(iii) (Howl's Moving Castle, is a unique work)

(iv) (Howl's Moving Castle, will be inspected)

(v) (Howl's Moving Castle, was taken in)

To arrange the predicates, the answer generating unit 207 narrows the predicates in accordance with the predicate narrowing condition to be used for generating answers, which condition was determined by the ambiguous question pattern holding unit 203. The predicates are narrowed, for example, on the condition such as:

“evaluation expression” . . . an adjective or expression comparable to an adjective;

“past expression” . . . expression in the past form; and

“change expression” . . . expression including a change-of-state verb

That is, the predicates are narrowed by a process of classifying the expression modes of the predicates. Any other narrowing condition may be defined likewise whenever it is used.

“Evaluation expression” is applied as the predicate narrowing condition to be used for generating answers by the ambiguous question pattern holding unit when the question is:

“Is ‘Howl's Moving Castle’ interesting?”

Thus, of the aforementioned pairs (i) to (v), only the following ones corresponding to the evaluation expression are selected and used for generating answers.

(i) (Howl's Moving Castle, is interesting)

(ii) (Howl's Moving Castle, was good)

(iii) (Howl's Moving Castle, is a unique work)

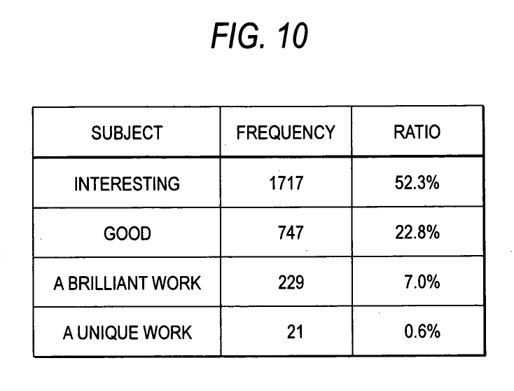

FIG. 10 shows data examples arranged by this narrowing process performed in an actual search process executed on trial. That is, when only passages having predicates with evaluation expression are selected from retrieved passages and classified, data shown in FIG. 10 are acquired.

The predicates to the subject “Howl's Moving Castle” are arranged as:

interesting: 1,717 cases, 52.3%

good: 747 cases, 22.8%

a brilliant work: 229 cases, 7.0%

a unique work: 21 cases, 0.6%

Data classified thus about the evaluation expression can be generated. The data are provided as answers to the user.

The related question generating unit 208 expands the input question (“Is ‘Howl's Moving Castle’ interesting?”) correspondingly to the predicates obtained by the answer generating unit 207. Thus, the related question generating unit 208 generates a related question. The expanded question is input as a new input question, and related information is output. This process is similar to the aforementioned process example.

When the process for narrowing predicates as answers is executed in accordance with the pattern of an input question in this manner, more accurate answers corresponding to the pattern of the input question can be obtained.

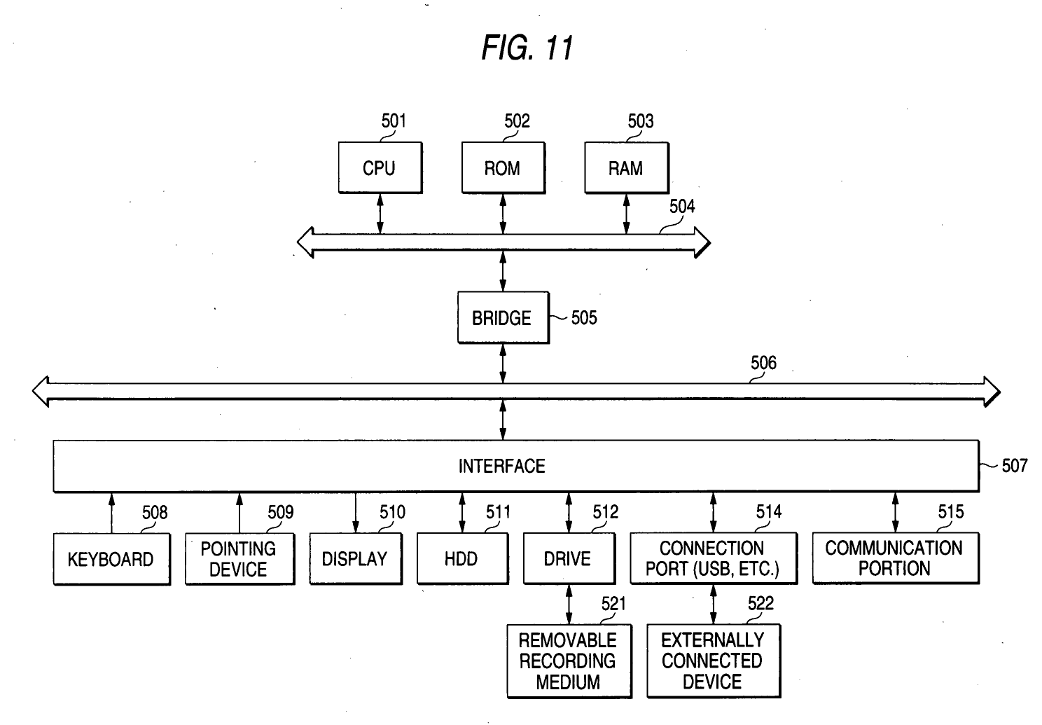

Finally, with reference to FIG. 11, description will be made about an example of the hardware configuration of an information processing apparatus constituting the question answering system for executing the aforementioned processing. A CPU (Central Processing Unit) 501 executes processes corresponding to an OS (Operating System) or processes described in the aforementioned embodiment, such as the ambiguous question determination process based on an input question, the question keyword identifying process, the passage acquiring process, the syntactic and semantic analysis process, the answer generating process, the related question generating process, etc. These processes are executed along computer programs stored in data storage portions such as ROMs, hard disks, etc. in various information processing apparatus.

A ROM (Read Only Memory) 502 stores programs and calculation parameters to be used by the CPU 501, etc. A RAM (Random Access Memory) 503 stores programs to be used for execution of the CPU501, parameters varied properly in that execution, etc. The ROM 502 and the RAM 503 are connected to each other through a host bus 504 constituted by a CPU bus or the like.

The host bus 504 is connected to an external bus 506 such as a PCI (Peripheral Component Interconnect/Interface) bus via a bridge 505.

A keyboard 508 and a pointing device 509 are input devices to be operated by the user. A display 510 is constituted by a liquid crystal display or a CRT (Cathode Ray Tube), displaying various information in text or image.

An HDD Hard Disk Drive) 511 includes hard disks. The HDD 511 drives the hard disks so as to record or reproduce programs to be executed by the CPU 501, or information. For example, the hard disks serves as a storage means for storing ambiguous question patterns, a list of answers, etc. Further, various computer programs such as data processing programs are stored in the hard disks.

In the condition that a removable recording medium 521 such as a magnetic disk, an optical disk, a magneto-optical disk or a semiconductor memory is mounted in a driver 512, the driver 512 reads data or programs recorded in the removable recording medium 521, and supplies the data or program to the RAM 503 connected through the interface 507, the external bus 506, the bridge 505 and the host bus 504.

A connection port 514 is a port for connecting an externally connected device 522 thereto. The connection port 514 has a connection portion of USB, IEEE1394 or the like. The connection port 514 is connected to the CPU 501 and so on through the interface 507, the external bus 506, the bridge 505, the host bus 504, etc. A communication portion 515 is connected to a network so as to carry out communication with clients or network-connected servers.

The example of the hardware configuration of the information processing apparatus applied to the question answering system as shown in FIG. 11 is an example of an apparatus arranged by use of a PC. The question answering system according to the invention is not limited to the configuration shown in FIG. 11. Any configuration may be used if it can execute the processes described in the aforementioned embodiment.

The invention has been described above in detail with reference to its specific embodiment. However, it is obvious to those skilled in the art that modifications or substitutions can be made on the embodiment without departing from the substance of the invention. That is, the invention has been disclosed in an exemplification form, but it should not be interpreted restrictively. The substance of the invention should be determined in consideration of its claims.

A series of processes described in this specification can be executed by hardware, by software or by a configuration where the both have been combined. When the processes are executed by software, programs where process sequences have been recorded can be installed and executed in a memory in a computer built in dedicated hardware. Alternatively, programs can be installed and executed in a general-purpose computer which can execute various processes.

For example, the programs can be recorded in a hard disk or a ROM (Read Only Memory) serving as a recording medium in advance. Alternatively, the programs can be stored (recorded) temporarily or permanently in a removable recording medium such as a flexible disk, a CD-ROM (Compact Disc Read Only Memory), MO (Magneto-Optical) disk, a DVD (Digital Versatile Disc), a magnetic disk, a semiconductor memory, etc. Such a removable recording medium can be provided as so-called packaged software.

The programs may be installed in the computer from the removable recording medium described above. Alternatively, the programs may be transmitted from a download site to the computer by wireless or by wire via a network such as a LAN (Local Area Network) or the Internet. The computer can receive the programs transmitted thereto in such a manner and install the received programs in a recording medium such as a hard disk included in the computer.

Various processes described in this specification may be executed in time series according to the described manner. The processes may be executed in parallel or individually in accordance with the throughput of an apparatus executing the processes or in accordance with necessity. A system in this specification has a configuration of a logical set of a plurality of devices, and the system is not limited to a configuration where the constituent devices are built in one and the same housing.

What is claimed is:

1. A question answering system comprising:
a question sentence analyzing unit that determines whether or not an input question sentence is an ambiguous question;
a question keyword identifying unit that extracts a question keyword from the input question sentence;
a passage acquiring unit that executes a search process to which the question keyword is applied; and
an answer generating unit that generates answers in a form of a list of predicates extracted correspondingly to the question keyword, based on passages acquired by the passage acquiring unit.

2. The system according to claim 1, further comprising:
an ambiguous question pattern holding unit that holds ambiguous question patterns, wherein:
the question sentence analyzing unit executes a process for comparing the input question sentence with the ambiguous question patterns held by the ambiguous question pattern holding unit, and determining whether or not the input question sentence is an ambiguous question.

3. The system according to claim 1, further comprising:
a syntactic and semantic analysis unit that executes a syntactic and semantic analysis process upon the passages acquired by the passage acquiring unit, the syntactic and semantic analysis unit that executes a process for extracting predicates corresponding to the question keyword from the passages, wherein:
the answer generating unit generates answers using the predicates, which correspond to the question keyword and are extracted by the syntactic and semantic analysis unit.

4. The system according to claim 1, further comprising:
a related question generating unit that generates related questions based on the predicates corresponding to the question keyword, wherein:
the question answering system generates answers using search results based on the questions generated by the related question generating unit.

5. The system according to claim 1, wherein the answer generating unit executes a process in which the predicates, which corresponding to the question keyword and are extracted from the passages acquired by the passage acquiring unit, are narrowed down in accordance with a pattern of the input question sentence.

6. The system according to claim 5, wherein the answer generating unit executes the predicate narrowing-down process by a process for classifying expressions of the predicates.

7. A data search method comprising:
determining whether or not an input question sentence is an ambiguous question;
extracting a question keyword from the input question sentence;
executing a search process to which the question keyword is applied to acquire passages including the question keyword; and
generating answers in a form of a list of predicates extracted correspondingly to the question keyword, based on the acquired passages.

8. The method according to claim 7, wherein the determining comprises comparing the input question sentence with ambiguous question patterns, to determine whether or the input question sentence is an ambiguous question.

9. The method according to claim 7, further comprising:
executing a syntactic and semantic analysis process upon the acquired passages; and
extracting predicates corresponding to the question keyword from the passages, wherein:
the generating generates answers using the extracted predicates correspond to the question keyword.

10. The method according to claim 7, further comprising:
generating related questions based on the predicates corresponding to the question keyword; and
generating answers using search results based on the related questions.

11. The method according to claim 7, wherein the answer generating comprises narrowing down the predicates, which correspond to the question keyword and are extracted from the acquired passages, in accordance with a pattern of the input question sentence.

12. The method according to claim 11, wherein the narrowing-down classifies expressions of the predicates.

13. A computer readable medium storing a program causing a computer to execute a process for searching for data, the process comprising:
determining whether or not an input question sentence is an ambiguous question;
extracting a question keyword from the input question sentence;
executing a search process to which the question keyword is applied to acquire passages including the question keyword; and
generating answers in a form of a list of predicates extracted correspondingly to the question keyword, based on the acquired passages.

14. A computer data signal embodied in a carrier wave for enabling a computer to perform a process for searching for data, the process comprising:
determining whether or not an input question sentence is an ambiguous question;
extracting a question keyword from the input question sentence;
executing a search process to which the question keyword is applied to acquire passages including the question keyword; and
generating answers in a form of a list of predicates extracted correspondingly to the question keyword, based on the acquired passages.
